(19) United States
(12) Patent Application Publication
(10) Pub. No.: US 2003/0064645 A1
(43) Pub. Date: Apr. 3, 2003

(54) Biocidal polyester and methods

(75) Inventors: Shelby D. Worley, Auburn, AL (US); Jian Lin, Auburn, AL (US); Royall M. Broughton JR., Auburn, AL (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Auburn University

(21) Appl. No.: 09/866,535

(22) Filed: May 25, 2001

(51) Int. Cl. B32B 5/02; B32B 27/12

(52) U.S. Cl. 442/123; 523/122

(57) ABSTRACT

Biocidal polyester fabrics, fibers and other materials, and methods of preparation. Heterocyclic N-halamine precursor moieties are covalently linked to the polyester material. The fabrics or fibers obtain antimicrobial activity after washing with a source of oxidative halogen such as a chlorine bleach by conversion of the precursor moieties into N-halamine functionalities. The antimicrobial activity can be repeatedly regenerated by further washing with aqueous oxidative halogen. The biocidal polyester fabrics, fibers, and other materials will be effective in reducing, or eliminating entirely, pathogenic and odor-causing microorganisms.

### FIELD OF THE INVENTION

This invention is in the field of antimicrobial materials; more particularly it relates to biocidal polyester fabrics, fibers, and other materials made from polyethylene terephthalate and other polyesters for use in preventing infections and noxious odor.

### BACKGROUND OF THE INVENTION

The colonization of microorganisms on the surfaces of fabrics, fibers, and other articles important to society can lead to the spread of infections and the production of noxious odors. There is a need for articles produced from biocidal polymeric materials so as to combat this problem. Antimicrobial polyester materials would be useful in producing textile fabrics for clothing, drapes, carpet fibers, and the like, as well as other articles produced from the polymers such as plastic soft-drink bottles, other blow-molded containers, recording tapes, photographic films, and the like.

An antimicrobial function can be added to the surfaces of polymeric materials in a variety of ways such as applied adhesive coatings after processing, blends during processing, and subjecting the polymeric material to chemical reactions during or after processing in which chemical bonds are formed. The adhesive coatings suffer the limitations of detachment over time, loss of porosity, and alteration of texture. The blends can cause deterioration of strength and other properties needed by the host polymer. All three methods generally lead to biocidal polymers which lose activity over time without the possibility of regeneration. However, recently a variety of polymers have been invented which contain N-halamine functional groups chemically bonded to the polymers, imparting biocidal activity which may be regenerated by exposure to free halogen (chlorine or bromine) following loss of activity. Such polymers are disclosed in S. D. Worley et al. U.S. Pat. Nos. 5,490,983; 5,670,646; 5,889,130; 5,902,818 and G. Sun et al. U.S. Pat. No. 5,882,357, the disclosures of which are hereby incorporated by reference. U.S. Pat. Nos. 5,490,983; 5,670,646; and 5,889,130 teach methods of producing polymeric water disinfectants, while U.S. Pat. Nos. 5,902,818 and 5,882,357 teach methods of forming biocidal films on surfaces and a biocidal cellulose, respectively. A recent U.S. patent application by S. D. Worley et al. (Ser. No. 09/615,184), its disclosure incorporated by reference, teaches the method of introducing N-halamine functional groups onto polyamides such as Nylon® and Kevlar®, thus rendering them biocidal. Other known techniques include those published in: U.S. Pat. No. 4,842,932 in which yams containing antimicrobial agents including bisphenoxarsines, bisphenarsazines, alkyl phosphate derivatives, and silver or platinum powder were disclosed; U.S. Pat. No. 5,561,183 in which antimicrobial and deodorant polyester containing zirconium phosphate and metal ions is disclosed; and U.S. Pat. No. 5,968,599 in which polyester containing the antibacterial agent pentachlorophenol is disclosed.

### SUMMARY OF THE INVENTION

The present invention provides antimicrobial polyester materials, including fabrics, fibers, and any other substrates, surfaces or materials which can be fabricated from polyesters. The materials of the present invention exhibit biocidal and deodorant properties. The biocidal polyesters are prepared in accordance with an aspect of the present invention by covalently linking heterocyclic N-halamine precursor compounds to them. The polyesters thereafter obtain antimicrobial activity through washing or other exposure to a halogenated solution containing a source of oxidative halogen (chlorine or bromine, preferably chlorine), to convert the heterocyclic precursor moieties into heterocyclic N-halamine moieties. Moreover, the antimicrobial activity against pathogenic or odor-causing microorganisms can be repeatedly regenerated by washings with or other exposures to a source of oxidative halogen in aqueous solution.

In one embodiment, the present invention provides a process for preparing biocidal precursor polyester fabrics, fibers, or material. The process entails the steps of: (a) using an aqueous base such as sodium hydroxide or ammonium hydroxide to hydrolyze ester moieties on the surface of the polyester material; (b) treating the thus modified polyester material with dilute aqueous ammonia and then optionally aqueous formaldehyde; (c) treating the modified polyester material from step (b) with an aqueous solution containing a heterocyclic N-halamine precursor compound, a catalyst, and a wetting agent to produce a polyester material with covalently linked precursor moieties; (d) curing the material created in step (c) at elevated temperature; and (e) rinsing the cured material with water.

In another embodiment, the present invention provides a process for rendering the precursor polyester fabrics, fibers, or other material antimicrobial, and for regenerating the antimicrobial activity of spent polyester fabrics, fibers, or other material that have previously been treated in accordance with the present invention but that have lost a significant degree of biocidal activity. The precursor polyester fabrics, fibers, or other material, or spent fabrics, fibers, or other material, are washed, immersed, or otherwise exposed to a solution containing oxidative halogen. In a preferred process, the halogenated solution is a chlorine solution or, alternatively, may suitably be a bromine solution. In a most preferred embodiment, the halogenated solution is a hypochlorite solution (e.g., a chlorine bleach solution such as Clorox®). The current disclosure teaches a method of introducing biocidal N-halamine functional groups onto polyester materials. The method used is different than that used previously for the other polymers from which biocidal textile products can be produced. The advantages of the current method disclosed herein, of utilizing N-halamine functionalities to render polyester antimicrobial, over prior methods, can be realized in lower cost, lower toxicity, and regenerability.

Other features, objects, and advantages of the invention and its preferred embodiments will become apparent from the following detailed description.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 provides a reaction scheme for the process of Example 1;

FIG. 2 provides a reaction scheme for the process of Example 2;

FIG. 3 provides a reaction scheme for the process of Example 9;

FIG. 4 provides a reaction scheme for the process of Example 10; and

FIG. 5 provides a reaction scheme for the process of Example 11.

### DETAILED DESCRIPTION OF THE PREFERRED EMBODIMENT

“Polyester fabrics, fibers, and other materials made from polyesters” as used herein refers to all materials primarily produced from polyesters, including but not limited to PET (polyethylene terephthalate). Examples of materials including, without limitation, woven and nonwoven fabrics and articles, carpets, solid surfaces, containers and films.

“Antimicrobial,” as used herein, refers to the ability to kill or substantially inhibit the growth of certain types of predetermined microorganisms. The fabrics, fibers, and other materials prepared in accordance with the present invention preferably have antimicrobial activity against a broad spectrum of pathogenic and odor-causing microorganisms. For example, the materials have antibacterial activity against representative Gram-positive bacteria (such as Staphylococcus aureus) and Gram-negative bacteria (such as Escherichia coli).

“Regenerable” refers to antimicrobial fabrics, fibers, and other materials treated in accordance with the present invention, that have obtained a reduced level of antimicrobial activity due to exposure to microorganisms or halogen reducing agents, and which are susceptible to being restored to approximately the initial level of antimicrobial activity.

“Heterocyclic N-halamine precursor compound,” as used herein, refers to a 4- to 7-member cyclic compound, wherein at least 3 members of the ring are carbon atoms, 1 to 3 members of the ring are nitrogen atoms, and 0 to 1 member of the ring is an oxygen atom. The compound contains at least one imide, amide, or amine group. No hydrogen atom is attached to the carbon atoms that are directly connected to the nitrogen atoms in the ring. The compound contains 1 to 3 carbonyl groups.

“Polyester precursor fabrics, fibers, or other materials” refers to polyester fabrics, fibers, or other materials to which heterocyclic N-halamine precursor compound moieties have been covalently bonded.

“Heterocyclic N-halamine,” as used herein, refers to a compound with one or more nitrogen-halogen covalent bonds, which are halogenated derivatives of the above heterocyclic N-halamine precursor compounds.

Examples of the heterocyclic N-halamine precursor compounds suitable for use in accordance with the present invention are: 3-hydroxymethyl-5,5-dimethylhydantoin, 1-hydroxymethyl-5,5-dimethylhydantoin, 1,3-dihydroxymethyl-5,5-dimethylhydantoin, 4-hydroxymethyl-4-ethyl-2-oxazolidinone, 3-hydroxymethyl-2,2,5,5-tetramethylimidazolidin-4-one, and hydroxymethyl derivatives of 6,6-dimethyl-1,3,5-triazine-2,4-dione, 4,4,5,5-tetramethyl -1,3-imidazolidin-2-one, and cyanuric acid.

Preferred N-halamine precursor compounds are: 3-hydroxymethyl-5,5-dimethylhydantoin, 1-hydroxymethyl-5,5-dimethylhydantoin, 1,3-dihydroxymethyl-5,5-dimethylhydantoin, 4-hydroxymethyl-4-ethyl-2-oxazolidinone, 3-hydroxymethyl-2,2,5,5-tetramethylimidazolidin-4-one.

The hydroxymethylhydantoin N-halamine precursor compounds used in the present invention are commercially available from several sources, e.g. Lonza, , Inc. (Fair Lawn, N.J.). Cyanuric acid is also commercially available from numerous sources, e.g. Aldrich, Inc. (Milwaukee, Wis.). In addition, those of skill in the art will appreciate that the heterocyclic N-halamine precursor compounds used in the present invention can be prepared by a variety of conventional synthetic techniques. It should be noted that many of these types of compounds are widely used in cosmetic products, and their halogenated derivatives are important disinfectants for use in, for example, swimming pool and cooling tower water. Thus, these compounds are not believed to generate toxic effects for humans or the environment either in terms of the treated materials or during the treatment process.

“Catalyst,” as used herein, refers to a substance which, when used in small quantities, augments the rate of a chemical reaction by a predetermined amount without itself being consumed. Examples of suitable catalysts for use in the present invention include magnesium salts, zinc salts, and ammonium salts. In preferred embodiments, the employed catalysts can be selected from the group magnesium chloride, magnesium nitrate, zinc nitrate, and ammonium nitrate.

“Wetting agent,” as used herein, refers to a substance which enhances the spreading of a liquid across a surface. Examples of suitable wetting agents in the preferred embodiment include Triton®X-100 (Sigma Chemical Company, St. Louis, Mo.), SEQUAWETT®(Sequal Chemical Company, Chester, S.C.), and AMWET® (American Emulsions Company, Dalton, Ga.).

In one embodiment, the present invention provides a process for preparing an N-halamine precursor polyester fabric, fiber, or other material. The process includes the steps of: (a) hydrolyzing a portion of the ester moieties on the surface of the polyester material preferably using an aqueous base such as sodium hydroxide or ammonium hydroxide; (b) treating the thus modified polyester material with dilute aqueous ammonia and then optionally aqueous formaldehyde; (c) treating the modified polyester material from step (b) with an aqueous solution containing a heterocyclic N-halamine precursor compound, a catalyst, and a wetting agent to produce a polyester material with covalently linked precursor moieties; (d) curing the material created in step (c) at elevated temperature; and (e) rinsing the cured material with water.

In step (a), if sodium hydroxide is the hydrolysis agent, its concentration should lie in the range 0.05 to 3.0 N, preferably at 0.5 N or lower, at a temperature suitably of less than or equal to 90° C., with a time of contact suitably less than or equal to 10 minutes. If ammonium hydroxide is the hydrolysis agent, its concentration should be less than or equal to 29.6%, at a temperature of about 35° C., with a contact time suitably less than or equal to 30 minutes. Another suitable hydrolysis agent is believed to be potassium hydroxide.

In step (b), if a hydrolysis agent other than ammonium hydroxide is used in step (a), dilute ammonium hydroxide (about 1.0 N) should be used at room temperature for five minutes; if ammonium hydroxide is used in step (a), further use of dilute ammonium hydroxide is not necessary. The use of ammonium hydroxide in step (b) is for the purpose of producing ammonium salts of the acid groups following hydrolysis of the ester. If the optional use of formaldehyde is then employed (to link the precursor ring to the PET), a 1.0 N solution held at 50° C. for 1 hour is sufficient.

In step (c), the aqueous treating bath comprises a heterocyclic N-halamine precursor compound, and preferably also a wetting agent and a catalyst. The concentration of the various components of the aqueous treating bath can be widely varied, depending on the components employed and the desired results. Typically the heterocyclic N-halamine precursor compound is present at a concentration ranging from 0.5% to 20%, preferably at a concentration of 5% to 10%. The wetting agent is typically present at a concentration ranging from 0.1% to 3%, preferably at a concentration ranging from 0.1% to 1%. The concentration of the catalyst depends on the concentration of the heterocyclic N-halamine precursor compound employed. Typically the weight ratio of catalyst to precursor compound should be in the range 1:5 to 1:20, preferably about 1:10. Those of skill in the art will appreciate that other additives such as softeners and waterproofing agents can be incorporated into the treating bath also to impart favorable characteristics to the polyester fabrics, fibers, or other materials. The pH of the treatment bath should be adjusted to 2 to 4, preferably 2.5 to 3.5. The temperature of the treatment bath should be in the range of ambient temperature to 100° C., more preferably 70 to 85° C. The time of exposure of the polyester in the treatment bath should be in the range 20 to 60 minutes, preferably 30 to 45 minutes.

In step (d), the material treated as above is dried in air and then cured under nitrogen or other inert atmosphere at a temperature ranging from 120 to 160° C., preferably from 130 to 150° C., for a period of time ranging from 0.5 to 2.0 hours, preferably from 0.5 to 1.0 hour. While curing an inert atmosphere is preferred, curing in air may be possible if the temperatures are determined and controlled to minimize oxidation.

In step (e), the treated material is rinsed free of treatment chemicals with water.

In a further aspect of the preferred embodiment, the present invention provides a process for rendering the polyester N-halamine precursor fabrics, fibers, or other materials with an antimicrobial component. The biocidal precursor fabrics, fibers, or other materials are washed with an aqueous solution of oxidative halogen, then rinsed in water, then dried. The source of oxidative halogen can be free chlorine, free bromine, or any N-halamine compound containing oxidative chlorine or bromine. In a preferred embodiment, the oxidative halogen source is free chlorine or an N-chloramine compound. In the most preferred embodiment, the oxidative chlorine source is free chlorine as would be obtained from a commercial bleach such as Clorox®. The concentration of active chlorine which is employed may suitably be in the range 0.25% to 2.6%, preferably 0.25% to 1.0% by weight. The washing with oxidative halogen solution not only renders the polyester material biocidal, but also sterilizes it. Repeated regeneration of biocidal activity following loss or partial loss of same can be obtained by further washing with aqueous oxidative halogen. For topping up the biocidal activity, chlorine concentrations in the range of 0.001% to 0.1%, preferably 0.05%, can be used.

The methods of the present invention can be suitably used to treat polyester fabrics, fibers, and other materials. The methods can be employed during or after the fabrication of the polyester materials. Such materials include clothing, drapes, carpets, photographic film, recording tape, soft-drink bottles, other blow-molded containers, and the like.

The invention will now be described in more detail by way of specific examples. The following examples are offered for illustrative purposes, and not for limiting the invention.

### EXAMPLE 1

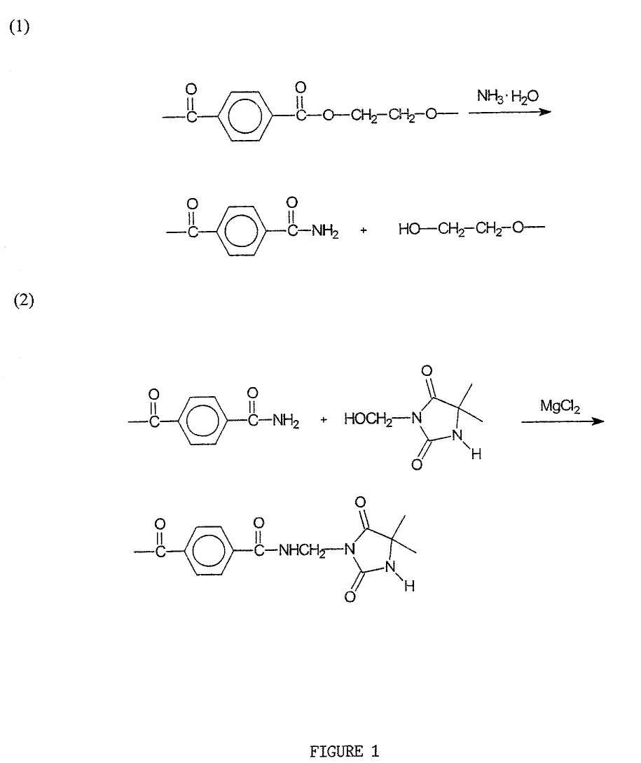

The exemplary reaction Scheme 1 of FIG. 1 illustrates the treatment of PET fabric with ammonium hydroxide followed by reaction with MDMH to produce a PET fabric which could subsequently be chlorinated and thus rendered biocidal.

A 3×3 inch square swatch of PET fabric was dipped in saturated ammonium hydroxide solution (29.6%) at 34° C. for a variable time of 0.5 to 3.0 hours followed by three distilled water rinses. A treating bath was prepared which contained 5.0 grams of MDMH (a mixture of 3-hydroxymethyl-5,5-dimethylhydantoin and 1-hydroxymethyl-5,5-dimethylhydantoin (Dantoin®)), 0.6 grams of magnesium chloride as a catalyst, 0.2 grams of Triton X-100 as a wetting agent, and 100 milliliters of distilled water. The pH of the bath was adjusted to 2.5 with 1% sulfuric acid solution. Then the fabric was dipped in the bath at 80° C. for 30 minutes. After drying, it was cured at 140° C. for 2.0 hours under a nitrogen atmosphere. Then it was washed with chlorine-demand-free (CDF) water (Scheme 1). Sample designations corresponding to treatment conditions are given in Table 1.

TABLE 1
Preparation Conditions for Samples in Example 1

| | Treatment with | | | |
|---|---|---|---|---|
| | Ammonium Hydroxide | | Treatment with Dantoin | |
| | Time | Temperature | Time of Curing | Temperature of |
| Sample^{a} | (hours) | (° C.) | (hours) | Curing (° C.) |
| PETAH-1 | 0.5 | 34 | 2.0 | 140 |
| PETAH-2 | 1.0 | 34 | 2.0 | 140 |
| PETAH-3 | 1.5 | 34 | 2.0 | 140 |
| PETAH-4 | 2.0 | 34 | 2.0 | 140 |
| PETAH-5 | 3.0 | 34 | 2.0 | 140 |

^{a}“PET” refers to polyethylene terephthalate; “A” refers to ammonium hydroxide pretreatment; “H” refers to subsequent treatment with MDMH.

### EXAMPLE 2

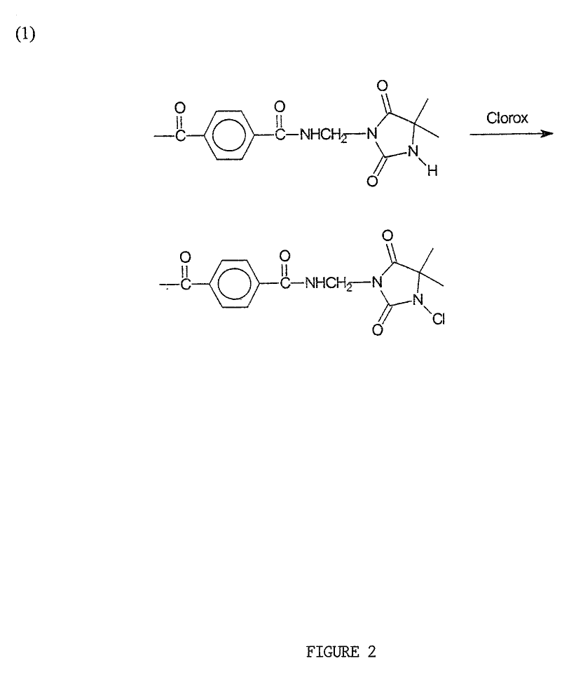

The exemplary reaction Scheme 2 shown in FIG. 2 illustrates how the PET fabric treated as described in Example 1 can be rendered biocidal. The samples were soaked in a solution of free chlorine (50% Clorox®) which contained 2.6% of sodium hypochlorite for 8.0 hours at room temperature (Scheme 2). Then they were rinsed with CDF water until free chlorine could not be detected in the effluent (<0.2 mg/L). Following drying in air, they were ready for antimicrobial testing against representative Gram-positive bacteria (such as Staphylococcus aureus (ATCC 5368)) and Gram-negative bacteria (such as Escherichia coli (ATCC 2666)). In the sample designations in later examples, the addition of a “C” will indicate those samples which have been chlorinated.

### EXAMPLE 3

This example illustrates the method used for antibacterial studies of the PET fabrics. Swatches of test and control fabrics can be tested quantitatively for antibacterial activity using AATCC Method 100. The following method is a modified version of the aforementioned method and is applicable for fabric swatches.

In the method, sized and shaped treated swatches were placed on sterile petri dishes. A known volume of inoculum containing bacteria of about 10⁸ CFU/mL (Staphylococcus aureus) in pH 7 buffer solution was used. For the inoculation procedure complete absorption of the bacterial solution was required with no free liquid being available. Swatches of unchlorinated, but otherwise identical fabric, were employed as controls. Sterilization of the samples was dependant on the type of fabric and finish.

Each swatch was inoculated with a known volume of inoculum insuring even distribution and, after a measured contact time, was transferred into a sterile wide mouthed glass vessel. The contact time varied depending upon the test requirements. Following the transfer, a known volume of neutralizing solution (0.02 N sodium thiosulphate) was added. The vessel and contents were shaken for a known time period. Aliquots of the resulting mixture were removed, and a set of serial dilutions was performed using pH 7 buffer. Typically dilutions of 10⁰ through 10⁶ were sufficient. A 0.025 mL aliquot of each dilution was then plated on Nutrient agar and incubated for a period of 48 hours. Bacterial counting was performed after 24 hours and 48 hours of incubation.

Table 2 sets forth the antimicrobial evaluations of the treated fabric. The processed fabric exhibited effective antibacterial properties independent of the time of ammonium hydroxide pretreatment.

TABLE 2
Antibacterial Swatch Testing for the Samples Treated with Ammonium
Hydroxide for Different Times

| | Challenge of | | |
|---|---|---|---|
| | S. aureus | Contact Time | Antibacterial Performance |
| Sample^{a} | (log) | (minutes) | (log reduction) |
| PETAHC-1 | 8.7 | 30 | 6.5-8.7 |
| PETAH-1 | 8.7 | 30 | 0 |
| PETAHC-2 | 8.7 | 30 | 6.5-8.7 |
| PETAH-2 | 8.7 | 30 | 0.1 |
| PETAHC-3 | 8.7 | 30 | 6.5-8.7 |
| PETAH-3 | 8.7 | 30 | 0.1 |
| PETAHC-4 | 8.7 | 30 | 6.5-8.7 |
| PETAH-4 | 8.7 | 30 | 0 |
| PETAHC-5 | 8.7 | 30 | 6.5-8.7 |
| PETAH-5 | 8.7 | 30 | 0 |

^{a}Sample designations were given in Table 1; the “C” indicates a chlorinated sample.

### EXAMPLE 4

This example illustrates the results of varying chlorination conditions for the treated PET samples. The PET fabric treated as in Example 1 was soaked in 50% or 100% Clorox® solution which contained 2.6% or 5.25% sodium hypochlorite, respectively, for different times at room temperature (Table 3). Then the swatches were rinsed with CDF water until less than 0.2 mg/L free chlorine could be detected in the effluent. Antimicrobial evaluation of the fabric samples against S. aureus were conducted as described in Example 3.

TABLE 3
Antibacterial Testing for Samples Chlorinated under Different Conditions

| | | | Challenge of | | Antibacterial |
|---|---|---|---|---|---|
| | Concentration | Time of | S. aureus | Contact Time | Performance |
| Sample | of Clorox ® | Chlorination | (log) | (minutes) | (log reduction) |
| PETAHC-6 | 50% | 8.0 hours | 8.9 | 30 | 6.5-8.9 |
| PETAHC-7 | 50% | 5.0 hours | 8.8 | 30 | 6.6-8.8 |
| PETAHC-8 | 50% | 3.0 hours | 8.9 | 30 | 6.7-8.9 |
| PETAHC-9 | 100% | 30 minutes | 8.7 | 30 | 6.5-8.7 |
| PETAHC-10 | 100% | 15 minutes | 8.7 | 30 | 6.5-8.7 |
| PETAHC-11 | 100% | 5 minutes | 8.7 | 30 | 6.5-8.7 |

The data in Table 3 illustrate that chlorination conditions chan be varied without loss of biocidal performance. Lower concentrations and/or shorter times during chlorination were not evaluated.

### EXAMPLE 5

This example illustrates the performance of the biocidal fabric at different bacterial contact times. PET fabric treated in the same manner as discussed in Example 1 was chlorinated with a 50% Clorox® solution containing 2.6% of sodium hypochlorite for 5.0 hours at room temperature. After rinsing with CDF water, the antimicrobial properties of the fabric for different contact times against S. aureus were evaluated; the results are presented in Table 4.

TABLE 4
Antibacterial Swatch Testing after Different Contact Times

| | | Challenge of | |
|---|---|---|---|
| | Contact Time | S. aureus | Antibacterial Performance |
| Sample^{a} | (minutes) | (log) | (log reduction) |
| PETAHC-12 | 30 | 9.1 | 6.9 |
| PETAH-12 | 30 | 9.1 | 1.9 |
| PETAHC-12 | 20 | 9.1 | 6.6 |
| PETAH-12 | 20 | 9.1 | 1.9 |
| PETAHC-12 | 10 | 9.1 | 5.3 |
| PETAH-12 | 10 | 9.1 | 0.9 |
| PETAHC-12 | 5 | 9.1 | 4.3 |
| PETAH-12 | 5 | 9.1 | 2.0 |

^{a}“C” indicates a chlorinated sample.

The results in Table 4 show that even when a very high challenge load of bacteria (9.1 logs) was employed, the chlorinated samples showed reasonable antibacterial activity, even at the shortest contact time (5 minutes) tested.

### EXAMPLE 6

This example illustrates stability of active chlorine on the biocidal PET. The samples were treated in the same manner as outlined in Example 1. After soaking in 50% Clorox® solution (2.6% sodium hypochlorite) for 8.0 hours at room temperature and rinsing with CDF water until less than 0.2 mg/L free chlorine could be detected in the effluent, the samples were allowed to dry in air and then challenged with S. aureus at various times over a two week period. The results of the testing are presented in Table 5.

TABLE 5
Antibacterial Swatch Testing after Several Days of Dry Storage

| | Time after | Challenge of | Contact | Microbiological |
|---|---|---|---|---|
| | Preparation | S. aureus | Time | Performance |
| Sample | (days) | (log) | (minutes) | (log reduction) |
| PETAHC-13 | 1 | 8.4 | 60 | 8.4 |
| PETAH-13 | 1 | 8.4 | 60 | 0.0 |
| PETAHC-13 | 5 | 8.3 | 60 | 8.3 |
| PETAH-13 | 5 | 8.3 | 60 | 1.2 |
| PETAHC-13 | 7 | 9.0 | 60 | 6.8 |
| PETAH-13 | 7 | 9.0 | 60 | 0.3 |
| PETAHC-13 | 14 | 9.0 | 60 | 6.8 |
| PETAH-13 | 14 | 9.0 | 60 | 0.2 |

From the data in Table 5 it is evident that the biocidal PET continued to be effective over a period of two weeks.

### EXAMPLE 7

This example illustrates that the biocidal property of the treated PET fabric can be regenerated after being lost. PET fabric samples were treated as described in Examples 1 and 6. One sample was exposed to 0.02 N sodium thiosulfate causing the loss of all active chlorine. That sample was then rechlorinated using the usual procedure. Then both samples were tested for antibacterial activity against S. aureus. Table 6 shows that the biocidal efficacy could be regenerated after being lost.

TABLE 6
Regeneration of Antibacterial Activity

| | | Challenge of | Contact | Microbiological |
|---|---|---|---|---|
| | | S. aureus | Time | Performance |
| Sample | Chlorination | (log) | (minutes) | (log reduction) |
| PETAHC-14 | First: 50% | 9.0 | 60 | 9.0 |
| | Clorox ® | | | |
| PETAH-14 | No | 9.0 | 60 | 0.3 |
| PETAHC-15 | Second: 50% | 9.0 | 60 | 9.0 |
| | Clorox ® | | | |
| PETAH-15 | No | 9.0 | 60 | 0.2 |

### EXAMPLE 8

This example illustrates that the PET fibers treated by the method of Example 1 do not significantly lose tensile strength. An Instron Model 1122 Tensile Tester was employed to determine the maximum load and percent elongation of the treated PET fibers upon reaching the point of breakage. A total of 10 one-inch fibers were tested for each sample with the results averaged. The tests were conducted at 21° C. and 65% relative humidity. The full-scale load on the constant-rate-of -extension Insotron was 50.0 lbf, and the crosshead speed employed was 10 in/min. The averaged data generated are presented in Table 7.

TABLE 7
Tensile Properties of PET Fibers by Single-strand Method (ASTM D
2256-97)

| | Displacement | Strain at | Tensile |
|---|---|---|---|
| | at Maximum | Maximum | Strength |
| Sample^{a} | (lbf) | (%) | (lbf) |
| PET original^{b} | 0.57 | 57 | 1.10 |
| PETAH-1 | 0.43 | 43 | 1.06 |
| PETAH-2 | 0.55 | 55 | 1.09 |
| PETAH-3 | 0.46 | 46 | 1.06 |
| PETAH-4 | 0.52 | 52 | 1.07 |
| PETAH-5 | 0.44 | 44 | 1.01 |

^{a}The samples were treated as in Example 1.
^{b}The sample was not treated, i.e., a control.

The standard deviations in the data were such that it can be stated that there was no significant difference between the treated fibers and the PET control fibers. In other words, the treatment conditions did not significantly affect the strength of the fibers. The chlorinated samples were not tested, but any significant weakening of the PET fibers should have occurred under the ester hydrolyses conditions, i.e., under the conditions of exposure to ammonium hydroxide as in Example 1.

### EXAMPLE 9

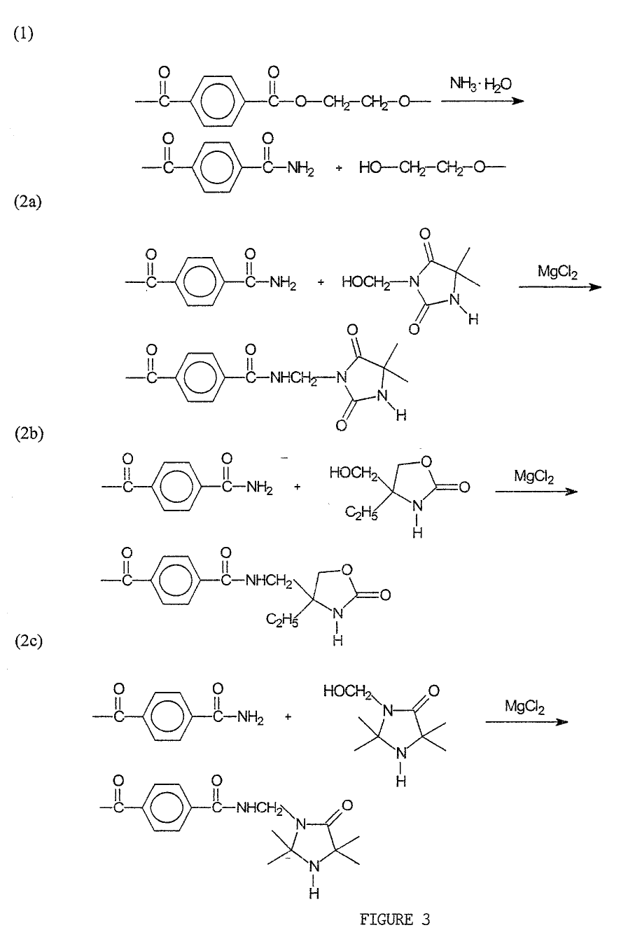

The exemplary reaction Scheme 3 shown in FIG. 3 illustrates that heterocyclic N-halamine precursors other than MDMH can be used to render the PET fabric biocidal upon subsequent chlorination. PET fabric was treated in the same manner as described in Example 1 (3 hours exposure to ammonium hydroxide) with three different heterocyclic compounds being employed. The compounds were MDMH to form PETAH-5, 4-hydroxymethyl-4-ethyl-2-oxazolidinone to form PETAO-5, and 3-hydroxymethyl-2,2,5,5-tetramethylimidazolidin-4-one to form PETAI-5 (see Scheme 3). Then the fabrics were soaked in 50% Clorox® solution which contained 2.6% sodium hypochlorite for 8.0 hours at room temperature, after which they were rinsed with CDF water until less than 0.2 mg/L free chlorine was detected in the effluent. After drying in air, the swatches of PETAHC-5, PETAOC-5, and PETAIC-5 were challenged with S. aureus as described in Example 3. The results of the bactericidal efficacy testing are shown in Table 8. Clearly all of the chlorinated samples were bactericidal.

TABLE 8
Antibacterial Swatch Testing for the Samples Treated with Different
Halamines

| | Challenge of | | |
|---|---|---|---|
| | S. aureus | Contact Time | Antibacterial Performance |
| Sample | (log) | (minutes) | (log reduction) |
| PETAHC-5 | 8.7 | 30 | 6.5-8.7 |
| PETAH-5 | 8.7 | 30 | 0.2 |
| PETAOC-5 | 8.8 | 30 | 6.6 |
| PETAO-5 | 8.8 | 30 | 0.9 |
| PETAIC-5 | 8.7 | 30 | 6.3-8.7 |
| PETAI-5 | 8.7 | 30 | 0.5 |

### EXAMPLE 10

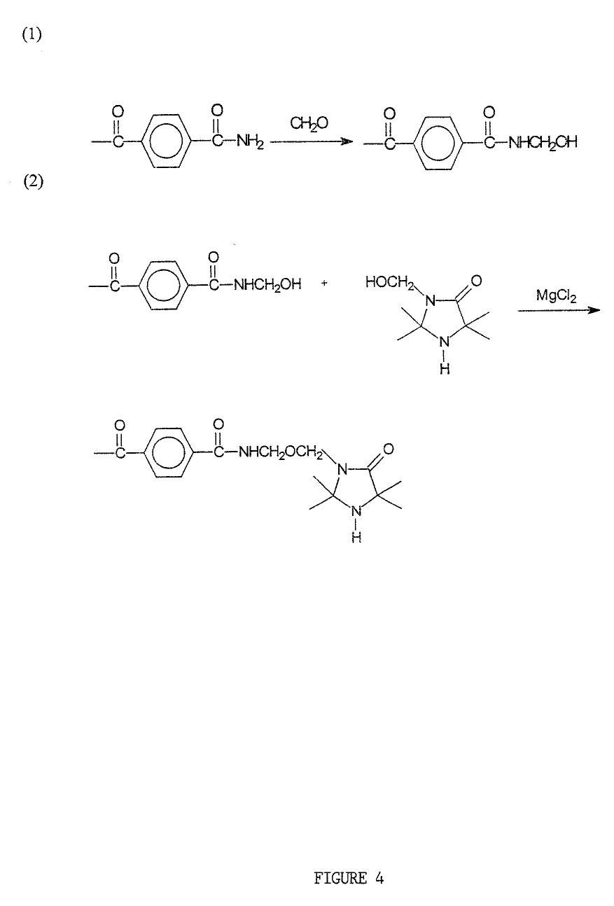

The exemplary reaction Scheme 4 shown in FIG. 4 illustrates that biocidal PET is effective against the Gram-negative bacterium Escherichia coli (ATCC 2666) as well as the Gram-positive bacterium S. aureus (ATCC 5368). In this example a slight modification to the synthetic procedure was employed, but the method taught in Example 1 should work just as well. In the modified synthetic procedure PET fabric was treated with ammonium hydroxide (29.6%) at 35° C. for 1.0 hour, rinsed with CDF water, and then soaked in 1.0 N formaldehyde solution at 50° C. for 1.0 hour (Scheme 4.). After further rinsing with CDF water, it was treated in a bath containing 5.0 g of MDMH, 0.4 g of magnesium chloride, 0.1 g Triton X-100, and 100 mL distilled water at a pH of 3.0 (adjusted with 1% sulfuric acid) at 50° C. for 30 min. After drying, the treated fabric was cured at 140° C. for 30 min, and then rinsed with CDF water. Chlorination was effected with 50% Clorox(t containing 2.6% sodium hypochlorite for 8.0 hours at room temperature, followed by rinsing in CDF water until less than 0.2 mg/L free chlorine could be detected in the effluent. The results of the bactericidal testing were as follows. The swatches caused a 5.7 log reduction (100%) of E. coli at a contact time of 10 min and a 64% reduction at a contact time of 5 min. The corresponding reductions for S. aureus were 99.98% at 10 min and 89% at 5 min. At a contact time of 60 min the reduction of S. aureus was 100% (8.5 logs). Adding formaldehyde to the preparation procedure did not seem to drastically affect the results obtained.

### EXAMPLE 11

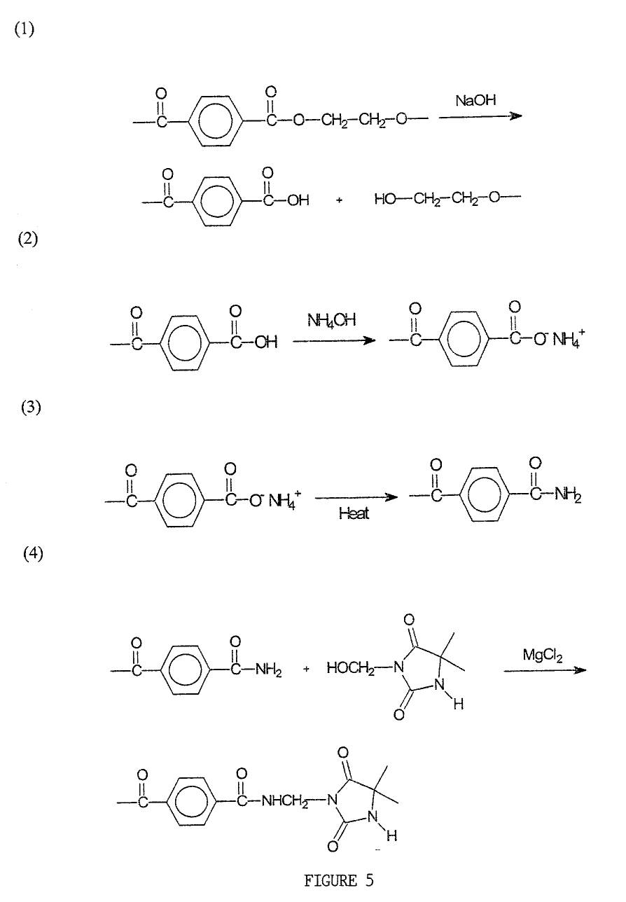

The exemplary reaction Scheme 5 shown in FIG. 5 illustrates that sodium hydroxide can be used in the ester hydrolysis procedure before the use of ammonium hydroxide. PET fabric swatches were soaked in 200 mL of three different concentrations of sodium hydroxide solution (0.5 N, 1.0 N, and 2.0 N), respectively, at 90° C. for 10 min. The fabric swatches were then rinsed with distilled water until the rinse water became neutral. Then the fabric swatches were soaked in dilute ammonium hydroxide solution (1 N) at room temperature for 5 min. The fabric swatches were then heated at 180° C. for 1.5 hours under a nitrogen atmosphere and rinsed with distilled water. The fabric swatches were then soaked in a treatment bath at 80° C. for 30 min containing 5 grams of MDMH, 0.4 grams of magnesium chloride as a catalyst, 0.2 grams of Triton X-100 as a wetting agent, and 100 milliliters of distilled water at a pH of 2.5 (adjusted with 1% concentration of sulfuric acid solution). After drying, they were cured at 140° C. for 1 hour under a nitrogen atmosphere and then rinsed with CDF water (Scheme 5).

The fabrics which were treated as described above were soaked in 50% Clorox® solution which contained 2.6% sodium hypochlorite for 8.0 hours at room temperature and then washed with CDF water until less than 0.2 mg/L free chlorine could be detected in the effluent. The results of bacterial efficacy testing against S. aureus are shown in Table 9. Also shown in Table 9 are the results for fabric swatches undergoing basic hydrolyses with sodium hydroxide, then treatment with ammonium hydroxide, and then treatment with 1.0 N formaldehyde as outlined in Example 10.

TABLE 9
Antibacterial Swatch Testing for the Samples treated with Different
Concentrations of Sodium Hydroxide in the Ester Hydrolysis Reaction

| | Challenge of | | Antibacterial |
|---|---|---|---|
| | S. aureus | Contact Time | Performance |
| Sample^{a} | (log) | (minutes) | (log reduction) |
| PETBAHC-1 | 8.3 | 60 | 8.3 |
| PETBAH-1 | 8.3 | 60 | 1.2 |
| PETBAHC-2 | 9.0 | 60 | 6.8-9.0 |
| PETBAH-2 | 9.0 | 60 | 0.3 |
| PETBAHC-3 | 8.7 | 60 | 6.5-8.7 |
| PETBAH-3 | 8.7 | 60 | 1.8 |
| PETBAFHC-1 | 8.7 | 60 | 6.5-8.7 |
| PETBAFH-1 | 8.7 | 60 | 0.4 |

^{a}The normality of the sodium hydroxide in the sample designation was: 1 = 0.5 N; 2 = 1.0 N; 3 = 2.0 N; F in the sample designation indicates that formaldehyde was also used in the treatment.

The results in the table indicate that all of the treatment conditions described in this example produced PET having biocidal activity. However, it should be noted that the fibers treated with sodium hydroxide as described above did lose as much as 50% of their tensile strength. Thus if sodium hydroxide is to be employed in hydrolysis of the polyester, conditions such as normality, temperature, and time of exposure should be moderated.

### EXAMPLE 12

This example illustrates the treatment of PET fabric with ammonium hydroxide followed by reaction with DMDMH to produce a PET fabric which could subsequently be chlorinated and thus rendered biocidal.

A 3×3 inch square swatch of PET fabric was dipped in saturated ammonium hydroxide solution (29.6%) at 34° C. for 3.0 hours. It was then rinsed three times with distilled water. A treating bath was prepared which contained 5% (w/w) of 1,3-dihydroxymethyl-5,5-dimethyl hydantoin (DMDMH, Lonza Inc., Annandale, N.J.), 1% (w/w) magnesium chloride as a catalyst, and 0.05% (w/w) of Triton X-100 as a wetting agent. The pH of the bath was adjusted to 2.5 with 1% sulfuric acid solution. Following the treatment with ammonium hydroxide, the fabric was soaked in the bath at 80° C. for 30 minutes. After drying, it was cured at 140° C. for 2.0 hours under a nitrogen atmosphere. Then it was washed with CDF water. The treated fabric was then chlorinated by soaking in a solution of free chlorine (50% Clorox®) which contained 2.6% of sodium hypochlorite for 8.0 hours at room temperature. Thus the treated sample was rinsed with CDF water until free chlorine could not be detected in the effluent (<0.2 mg/L).

Following drying in air, the fabric was tested against S. aureus (ATCC 5368) as described in Example 3. The results of the testing are shown in Table 10. The processed fabric exhibited bactericidal properties for a period of at least 15 days.

TABLE 10
Antibacterial Swatch Test for Samples Treated with DMDMH

| | | | Challenge | | |
|---|---|---|---|---|---|
| | | Time After | of | Contact | Antibacterial |
| | Sample | Preparation | S. aureus | Time | Performance |
| | Name^{a} | (Days) | (log) | (minutes) | (log reduction) |
| 1 | PETADH | 1 | 8.6 | 10 | 0.0 |
| 2 | PETADHC | 1 | 8.6 | 10 | 6.0-8.6 |
| 3 | PETADH | 7 | 8.6 | 10 | 0.0 |
| 4 | PETADHC | 7 | 8.6 | 10 | 2.0 |
| 5 | PETADH | 15 | 8.5 | 30 | 0.0 |
| 6 | PETADHC | 15 | 8.5 | 30 | 1.5 |

^{a}PETADH refers to sample treated with ammonium hydroxide and then DMDMH; PETADHC refers to chlorinated sample.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for preparing a precursor to a polyester material which can be subsequently rendered biocidal, comprising:
(a) using a hydrolysis agent to cleave at least a portion of the ester moieties on the surface of the polyester material to produce a modified polyester;
(b) during or after the hydrolysis of step (a), exposing the polyester material to aqueous ammonia to form a linking moiety.
(c) treating the modified polyester material from step (b) with an aqueous solution containing a heterocyclic N-halamine precursor compound to produce a polyester material with covalently linked precursor moieties;
(d) curing the material with covalently linked precursor moieties at elevated temperature; and
(e) rinsing the cured material free of unreacted treatment chemicals.

2. The method claim 1, wherein the hydrolysis agent comprises aqueous ammonia.

3. The method of claim 1, wherein the hydrolysis agent comprises sodium hydroxide.

4. The method of claim 3, wherein the concentration of aqueous ammonia used in step (b) is in the range of 0.1 to 2.0 N.

5. The method of claim 2, further comprising treating the modified polyester with aqueous formaldehyde, after treatment with aqueous ammonia and before treatment with the heterocyclic N-halamine precursor compound.

6. The method of claim 2, wherein the concentration of aqueous formaldehyde is in the range of 0.5 to 2.0 N.

7. The method of claim 1, wherein the polyester material comprises a woven or unwoven fabric or fibers.

8. The method of claim 1, wherein the polyester material comprises polyethylene terephthalate.

9. The method of claim 1, wherein the hydrolysis agent in step (a) comprises sodium hydroxide at a concentration in the range 0.05 to 3.0 N.

10. The method of claim 1, wherein the hydrolysis agent in step (a) comprises ammonium hydroxide at a concentration in the range 1.0 N to 29.6%.

11. The method of claim 1, wherein the heterocyclic N-halamine precursor compound is selected from the group consisting of 3-hydroxymethyl-5,5-dimethylhydantoin, 1-hydroxymethyl-5,5-dimethylhydantoin, 1,3-dihydroxymethyl -5,5-dimethylhydantoin, 4-hydroxymethyl-4-ethyl-2-oxazolidinone, 3-hydroxymethyl-2,2,5,5-tetramethylimidazolidin-4-one, and hydroxymethyl derivatives of 6,6-dimethyl-1,3,5-triazine-2,4-dione, 4,4,5,5-tetramethyl-1,3-imidazolidin-2-one, and cyanuric acid.

12. The method of claim 11, wherein the heterocyclic N-halamine precursor compound is selected from the group consisting of 3-hydroxymethyl-5,5-dimethylhydantoin, 1-hydroxymethyl-5,5-dimethylhydantoin, 1,3-dihydroxymethyl -5,5-dimethylhydantoin, 4-hydroxymethyl-4-ethyl-2-oxazolidinone, and 3-hydroxymethyl-2,2,5,5-tetramethylimidazolidin-4-one.

13. The method of claim 1, wherein the treatment solution used to produce polyester material with covalently linked precursor moieties further comprises a wetting agent.

14. The method of claim 13, wherein the wetting agent is selected from the group consisting of TRITON®X-100, SEQUAWET®, and AMWET®.

15. The method of claim 1, wherein the treatment solution used to produce polyester material with covalently linked precursor moieties further comprises a catalyst.

16. The method of claim 15, wherein the catalyst is selected from the group consisting of magnesium chloride, magnesium nitrate, zinc nitrate, and ammonium nitrate.

17. The method of claim 1, wherein the material with covalently linked precursor moieties is cured at a temperature in the range 120 to 160° C.

18. The method of claim 1, further comprising the step of exposing the treated precursor polyester material to an aqueous solution of a compound containing an oxidative halogen to produce an active biocidal material.

19. The method of claim 18, wherein the halogen comprises chlorine or bromine.

20. The method of claim 16, wherein the halogen comprises free chlorine at a concentration in the range of 0.001 to 2.6 weight percent.

21. The precursor treated polyester material produced by the method of claim 1.

22. A method for regenerating a biocidal polyester material, comprising:
(a) obtaining a polyester material to which is covalently bonded a heterocyclic N-halamine precursor compound including nitrogen atoms to which sufficient oxidative halogen was previously bound to exhibit a predetermined initial level of antimicrobial effect, that has been lowered to a reduced level of antimicrobial effect due to loss of halogen; and
(b) exposing the polyester material to an aqueous solution containing oxidative halogen so as to restore the antimicrobial effect to approximately the predetermined initial level.

23. A biocidal polyester material, comprising:
(a) a polyester substrate;
(b) heterocyclic N-halamine precursor moieties covalently linked to the polyester material; and
(c) halogen atoms bonded to the nitrogen atoms of the N-halamine precursor moieties to produce a biocidal surface on the polyester material.

24. The material of claim 23, wherein the polyester substrate comprises polyethylene terephthalate.

25. The material of claim 23, wherein the polyester substrate comprises woven or unwoven fabric or fibers.

26. The material of claim 23 wherein said heterocyclic N-halamine precursor is selected from the group consisting of 3-hydroxymethyl-5,5-dimethylhydantoin, 1-hydroxymethyl-5,5dimethylhydantoin, 1,3-dihydroxymethyl-5,5-dimethylhydantoin, 4-hydroxymethyl-4-ethyl-2-oxazolidinone, 3-hydroxymethyl-2,2,5,5-tetramethylimidazolidin-4-one, and hydroxymethyl derivatives of 6,6-dimethyl-1,3,5-triazine-2,4-dione, 4,4,5,5-tetramethyl-1,3-imidazolidin-2-one, and cyanuric acid.

27. The material of claim 26 wherein said heterocyclic N-halamine precursor is selected from the group consisting of 3-hydroxymethyl-5,5-dimethylhydantoin, 1-hydroxymethyl-5,5-dimethylhydantoin, 1,3-dihydroxymethyl-5,5-dimethylhydantoin, 4-hydroxymethyl-4-ethyl-2-oxazolidinone, 3-hydroxymethyl-2,2,5 ,5-tetramethylimidazolidin-4-one.
